(19) United States
(12) Patent Application Publication
(10) Pub. No.: US 2005/0281400 A1
(43) Pub. Date: Dec. 22, 2005

(54) System and method of identifying to the called party the identity of individual caller

(76) Inventor: Michael A. Zeiler, Salem Township, OH (US)

Correspondence Address: Thomas J. Onka, Esq.;Synnestvedt Lechner & Woodbridge LLP, P.O. Box 592, Princeton, NJ, 08542, US

(21) Appl. No.: 10/871,259

(22) Filed: Jun. 18, 2004

(51) Int. Cl. H04M 11/00; H04M 1/56; H04M 15/06

(52) U.S. Cl. 379/142.06; 379/142.05

(57) ABSTRACT

A telephone system is described in which a called party is serviced by a local switch, and where a calling individual is permitted to enter his/her preprogrammed identification number (ID#) and thereby enable the system to provide his identity to the called party. Additionally, the system further permits the calling individual to signal the local switch to implement additional features such as identifying the call as “urgent”.

### FIELD OF THE INVENTION

The present invention relates to a telecommunication system and method which permits the actual identity of the originator of a telephone call to be displayed to the party being called.

### BACKGROUND OF THE INVENTION

Even with a telephone caller identification (caller ID) feature, little information is provided the called party with respect to the actual calling party. That is, while the caller ID feature can provide the number or name listed on the dial tone account; this may not be the person who initiated the call. For instance, in a residential setting, a call may be placed by a roommate or guest. The examples of lack of knowledge about the calling party quickly expand when one considers phone calls originating from institutions (for example, hotels, hospitals, airports, offices, prisons, universities, etc.). Then consider mobile phones (Personal Communication System (PCS)/Service), air phones, maritime phones, and cellular phones, and it soon becomes apparent how little information is really known about a calling party. A public phone (such as a pay phone) in a lobby of an institution provides little if any information about the calling party especially if the calling party is paying cash for the call.

One can readily appreciate situations in which the distinction between identifying the calling individual rather than the calling phone is important to the called party. Accordingly, there are numerous situations in which it would be advantageous to the calling individual to have his true identity displayed to the called party. By way of example, the called party may be on a call and does not want to have his conversation disturbed unless it is very important and/or is pertinent to that conversation. In such a situation, the true identity of the calling individual would be of significant value in the called party's decision whether or not to accept an incoming call.

Accordingly, a need exists in the prior art to provide the called party with the actual identity of the calling individual in situations where the conventional caller ID feature would not provide this information, such as when the call is not originating from the calling individual's own phone.

### SUMMARY OF THE INVENTION

The present invention is directed to a system which allows a calling individual to enter his/her preprogrammed identification number (ID#) and thereby enable the system to provide the called party the identify of the calling individual. The present invention is implemented using an on-site switch or Private Branch Exchange (PBX) which services the called party's phone. In additional embodiments of the invention, the system recognizes various numbers and codes entered by the calling individual to not only effect the calling individual's identification, but also to implement additional features such as identifying the call as “urgent” or invoking a delay in a call about to be routed to the called party's voice mail to thereby permit the called party time to answer the call.

### BRIEF DESCRIPTION OF THE DRAWINGS

Various embodiments of the present invention will now be described in detail in conjunction with the annexed drawings, in which:

FIG. 1 is a block diagram of the primary elements of a telephone network wherein one embodiment of the system of the present invention may be implemented;

FIG. 2 is a flow diagram illustrating an embodiment of the invention in which a call is processed by an automated attendant feature of the local switch, and,

FIG. 3 is a flow diagram illustrating an embodiment of the invention in which a call is processed by voice mail features of the local switch.

### DETAILED DESCRIPTION

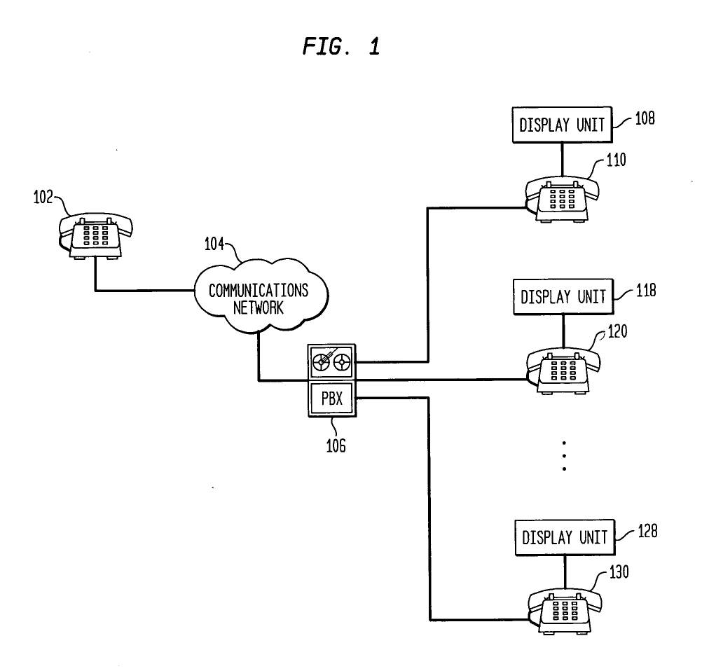

The present invention is implemented on an on-site, local switch which services the called party's phone. An example of such a switch is a DEFINITY model PBX, marketed by Avaya, Inc. of Basking Ridge, N.J. FIG. 1 is a block diagram which illustrates a communication system which employs such an on-site switch 106. As illustrated, the local switch 106 services a plurality of phone instruments 110, 120 and 130. In the example illustrated, each of these phones is equipped with a display unit (e.g., phone 110 has display unit 108) that is capable of displaying a caller ID to the user.

In one embodiment of the invention, the system processes internal calls, calls that both originate and terminate under the control of the PBX 106. By way of example, an individual would originate a call at phone 130. Assuming this is not the calling individual's regular phone and he wishes to alert the called party to his true identity, he would enter the following exemplary data character stream, i.e., a sequence of numbers and characters entered by the calling individual with his touch tone key pad:
4016*0930#,
   where 4016 is the extension of the called party,
      “*” is an indicator to the system that the calling individual's preprogrammed ID# immediately follows (here, “0930”), and
      “#” indicates to the system that the sequence is complete.

In this embodiment, the individual's ID# has been previously entered in to the data base of the local switch 106. This local switch converts the ID# and displays the calling individual's identity on called party's phone display unit (e.g., 108).

In an alternative embodiment for use in such internal calls, the digits entered following the “*” indicator may be simply the calling individual's normal extension. Obviously this later embodiment has the advantage of greater ease of use for the calling individual (one less ID# for the calling individual to remember). However, any calling individual can enter any valid extension as being “his identity” thereby potentially compromising the integrity of the identification system. Accordingly, this embodiment is recommend for use only in specific office environments.

In a further embodiment of the invention, the calling individual would enter the following exemplary sequence:
4016*0930*#,
   where the items entered are the same as the example above with the addition of another indicator (here, a second “*” indicator) which is used to show that the call is to be characterized as “urgent”. This urgent indicator would result in some appropriate message being displayed on the called party's display unit (e.g., 108) or cause some audible signal (e.g., a special ring signal) at the called party's phone. In additional embodiments, such an “urgent” call would be recognized by the local switch 106 in situations where the call is to programmed to be routed to the called party's voice mail (e.g., at a time when that individual is not taking any calls). The actual transfer to voice mail would be delayed by some settable time period to allow the called party sufficient time to view the identity of the calling individual and intercept the voice mail-bound call. Alternative embodiments of the invention would implement such a delay utilizing an alternative indicator which could be utilized by the calling individual when the nature of the phone call is not truly “urgent”. Accordingly, this permits the “urgent” designation to be invoked only when appropriate.

In either of these above described embodiments, the local switch 106 would recognize the “*” indicator in the input string and perform the necessary functions described above. That is, it would parse the inputted string to obtain the calling individual's ID#, convert this number to the calling individual's name, and display in on the called party's display unit. The called party would be permitted to see the calling individual's name and the extension he is calling from on his phone's display as the call “rings in”—even in a call waiting situation. Various further embodiments of the invention would permit, under appropriate conditions (e.g. “Urgent”), this signaling and identification to occur even when the called party has activated his phone's “Do Not Disturb” feature. Still further, alternative means of providing audible identification of the calling party to a visually impaired called party are contemplated by the invention—e.g., by various special ring tones corresponding to specific calling individuals.

Local switches (such as Avaya's DEFINITY model PBX) can accommodate programming changes to recognize specific inputted characters, such as the “*” indicator and can be further programmed to perform the functions described above. It should be noted that in the above exemplary inputted sequences, the called party's extension appears first, followed by the calling individual's ID#. The invention is not so limited as any order of the inputted information is contemplated by the invention.

Additional embodiments of the invention address situations in which a call is originated from a phone (e.g., phone 102) outside the local switch area. The ability to recognize the calling individual's identity in these situations can be very useful for important clients or for traveling employees who frequently call from unfamiliar locations. When such an external call comes in to a main number and an automated attendant then directs the call to the called party's extension, the invention can implement the above described features in the same way as described above with respect to an internal call.

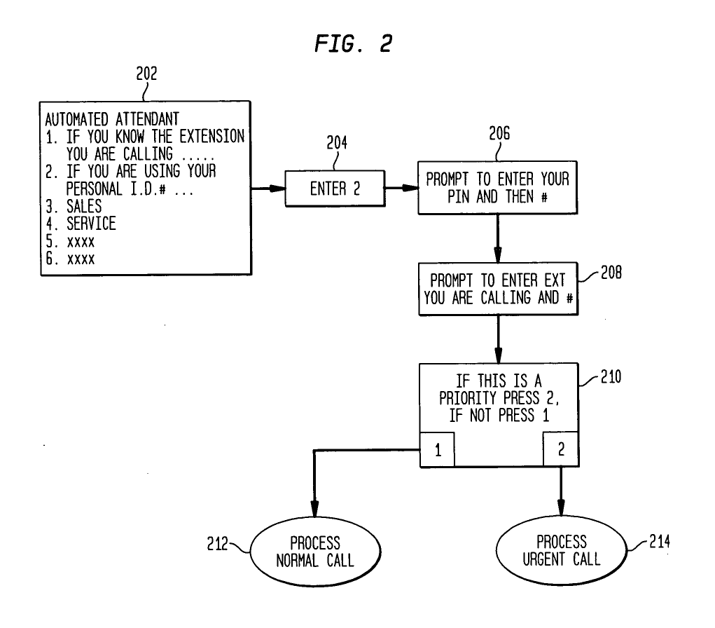

FIG. 2 illustrates an exemplary manner in which an automated attendant feature of the local switch can be utilized in the present invention. In particular, the call is initially “answered” by the automated attendant 202 which then provides the calling individual with a menu of options from which to select. Thus, entering a “1” permits the calling individual to enter the desired extension of the called party while entering a “3” or a “4” transfers the call to the sales department or service department, respectively. These features are well-known in the art. Entering a “2”, item 204 in this example, invokes the feature of the invention where the personal ID# of the calling individual can be entered at step 206. The system then at step 208 prompts the calling individual for the desired extension. Step 210 then provides the calling individual the opportunity to identify the call as “Urgent”. Depending on the calling individual's input, the call is then transferred to the called party as either a normal call 212 or as an “Urgent” call 214. In the latter case, the call would then be processed as described above with respect to an “Urgent” internal call.

In situations where an external call is dialed directly to an extension, further embodiments of the invention would have the local switch provide the calling individual with the option of entering his ID#. In one such embodiment, the system would provide the individual with two simple menu options: enter “1” to have the call immediately transferred to the extension dialed; enter “2” to permit the calling individual to enter his ID# prior to the call being transferred to the extension dialed. In the latter case, entry of the ID# would result in the identity of the calling individual then being transmitted to the called party's phone, as described above. Further embodiments of the invention would include additional menu options to permit implementation of the additional features noted above, such as an “Urgent” designation and/or a delay on a potential transfer to the called party's voice mail.

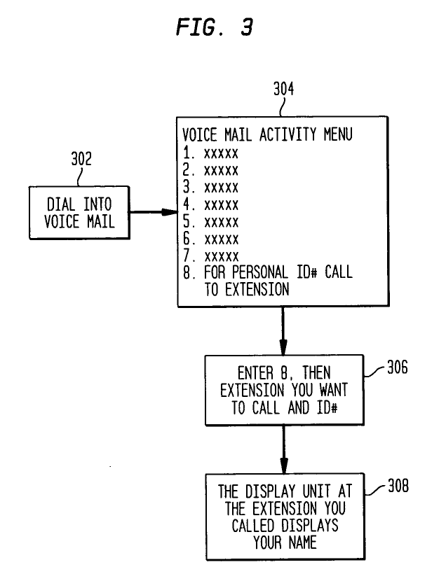

FIG. 3 illustrates a further embodiment of the invention in which an external call is handled by the system through the local switch's voice mail processing system. In particular, the calling individual dials into the local switch's voice mail system. As illustrated at item 304, a voice mail activity menu is then presented to the calling individual. As is well-known in the art, it is not usually necessary for the entire menu to be presented to the calling individual, who would be familiar with the system and its menu choices (as he is required to have his ID# registered on the system) and would be permitted to make his selection at any time while the menu is being presented. In this example, selection of item 8 results in the calling individual being prompted at step 306 to enter the desired called extension as well as his ID#. At step 308 the system then displays to the called party the true identity of the calling individual. Although not specifically illustrated, further embodiments of the invention would permit this voice mail system to invoke the various features of the invention described above (e.g., an “Urgent” call designation) as well as displaying the conventional ANI caller ID, that is, the phone number which originated the call.

While the invention has been described with reference to the preferred embodiment thereof, it will be appreciated by those of ordinary skill in the art that modifications can be made to the structure and elements of the invention without departing from the spirit and scope of the invention as a whole.

1. A communications system for handling a call placed by a calling individual to a called party's phone, said call placed from a phone instrument not identifiable with the calling individual, wherein the identity of the calling individual is provided to the called party's phone, said system comprising:
a local switch which services the called party's phone;
a data base associated with said local switch, said data base containing a correspondence between the calling individual's identification number (ID#) and his identity;
a means for entering by the calling individual a data character stream, said stream comprising a first indicator character and the calling individual's ID#;
a means for converting said calling individual's ID# into the identity of the calling individual and transmitting said identity to the called party's phone.

2. The communication system of claim 1 wherein the data character stream further comprises the extension number of the called party's phone.

3. The communication system of claim 1 wherein the data character stream further comprises a second indicator which indicates to the system that an “Urgent” call classification is to be transmitted to the called party's phone.

4. The communication system of claim 1 wherein the data character stream further comprises a third indicator which indicates to the system that the call should be delayed prior to being transferred to a voice mail box associated with the called party's phone.

5. The communication system of claim 1 wherein at least some of the information transmitted to the called party's phone is displayed on a display unit associated with that phone.

6. The communication system of claim 1 wherein at least some of the information transmitted to the called party's phone results in audible signals being generated at the called party's phone.

7. A communications system for handling a call placed by a calling individual to a called party's phone, said call placed from a phone instrument not identifiable with the calling individual, wherein the identity of the calling individual is provided to the called party's phone, said system comprising:
a local switch which services the called party's phone;
a data base associated with said local switch, said data base containing a correspondence between the calling individual's identification number (ID#) and his identity;
a means for prompting the calling individual to enter his ID#;
a means for converting said calling individual's ID# into the identity of the calling individual and transmitting said identity to the called party's phone.

8. The communication system of claim 7 wherein the means for prompting is selected from the group consisting of an automated attendant and a voice mail processing system, and combinations thereof.

9. The communication system of claim 7 wherein the means for prompting further comprises prompting the calling individual to designate the call as “Urgent”.

10. The communication system of claim 7 wherein at least some of the information transmitted to the called party's phone is displayed on a display unit associated with that phone.

11. The communication system of claim 7 wherein at least some of the information transmitted to the called party's phone results in audible signals being generated at the called party's phone.

12. In a telephone call placed from a calling individual to a called party's phone, said phone being serviced by a local switch, a method of providing to the called party's phone the identity of the calling individual when said call was placed from a phone instrument not identifiable with the calling individual, said method comprising:
establishing a data base associated with said local switch, said data base containing a correspondence between the calling individual's identification number (ID#) and his identity;
entering by the calling individual a data character stream, said stream comprising a first indicator character and the calling individual's ID#;
converting said calling individual's ID# into the identity of the calling individual; and,
transmitting said identity to the called party's phone.

13. The method of claim 12 wherein said entering step comprises entering the extension number of the called party's phone.

14. The method of claim 12 wherein said entering step further comprises entering a second indicator which indicates to the system that an “Urgent” call classification is to be transmitted to the called party's phone.

15. The method of claim 12 wherein said entering step further comprises entering a third indicator which indicates to the system that the call should be delayed prior to being transferred to a voice mail box associated with the called party's phone.

16. The method of claim 12 further comprising:
displaying on a display unit associated with the called party's phone at least some of the information transmitted.

17. The method of claim 12 further comprising:
generating audible signals at the called party's phone corresponding to at least some of the information transmitted.

18. In a telephone call placed from a calling individual to a called party's phone, said phone being serviced by a local switch, a method of providing to the called party's phone the identity of the calling individual when said call was placed from a phone instrument not identifiable with the calling individual, said method comprising:
establishing a data base associated with said local switch, said data base containing a correspondence between the calling individual's identification number (ID#) and his identity;
prompting the calling individual to enter his ID#;
converting said calling individual's ID# into the identity of the calling individual; and,
transmitting said identity to the called party's phone.

19. The method of claim 18 wherein said prompting step further comprises prompting the calling individual to designate the call as “Urgent”.

20. The communication system of claim 18 further comprising:
displaying on a display unit associated with the called party's phone at least some of the information transmitted.
